(19) United States
(12) Patent Application Publication
(10) Pub. No.: US 2003/0176225 A1
(43) Pub. Date: Sep. 18, 2003

(54) Balanced oscillating tool

(76) Inventors: Hansjoerg Besch, Moessingen (DE); Jianhua Li, Luebeck (DE); Detlef Klotz, Leinfelden-Echterdingen (DE)

Correspondence Address: ST. ONGE STEWARD JOHNSTON & REENS, LLC, 986 BEDFORD STREET, STAMFORD, CT, 06905-5619, US

(21) Appl. No.: 10/320,307

(22) Filed: Dec. 16, 2002

(30) Foreign Application Priority Data
Dec. 19, 2001 (DE) 101 64 081.1

(51) Int. Cl. B25B 13/00; F16C 3/00

(52) U.S. Cl. 464/180; 81/185.2

(57) ABSTRACT

The invention discloses an oscillating tool having an attachment opening for attachment to a drive shaft of an oscillating drive that can be driven oscillating about a pivot axis. Spaced from the attachment opening is provided a working section for processing a work piece. The oscillating tool is provided with a balancing section by which balancing of the oscillating tool relative to the pivot axis of the drive shaft, on which the oscillating tool is mounted, is achieved.

### BACKGROUND OF THE INVENTION

The present invention relates to an oscillating tool having an attachment opening for attachment to a drive shaft of an oscillating drive, that can be driven in oscillating fashion, and a working section, spaced from the attachment opening, for processing a work piece.

An oscillating tool of this kind is known, for example, from EP 0 174 427 A1. The known oscillating tool is designed as a cutting knife for cutting through adhesive beads on glass panels of motor vehicles and is used in combination with an oscillating drive. The known oscillating tool comprises an attachment opening for positively connecting the tool with the drive shaft of an oscillating drive, which is driven in oscillating fashion, and may as such take various different forms, such as a sickle-shaped form, a shape bent off in the form of a U, of the like.

In addition to being used as cutting knives, oscillating tools are used in combination with oscillating drives for a great number of other tasks, for example for sawing, scraping, or the like. By way of example, saw blades driven in the described oscillating fashion can be employed for making precise cuts in body workshops. Moreover, finger-like tools are in use for sawing in areas that are difficult to access in order to make special cuts, for example in the wood construction field. Another application of such tools is grinding, as described for example in EP 0 244 465 A1, or scraping.

Oscillating tools of that kind are driven to oscillate at high frequency about the pivot axis of the drive shaft of the oscillating drive. The vibrations produced in this way are felt by some users as a disadvantage. Also, in certain special applications the oscillating movement may have the effect that the oscillating tool sometimes cannot be applied on, or be moved relative to, the work piece with the desired precision.

### SUMMARY OF THE INVENTION

Therefore, it is an object of the present invention to provide an improved oscillating tool that can be used with an oscillating drive and that avoids, or at least reduces, the disadvantages described above.

It is another object of the invention to disclose a balancing weight suitable for balancing an oscillating tool which was previously unbalanced.

Also a method of balancing an oscillating tool shall be disclosed.

These and other objects of the invention are solved by providing an oscillating tool of the afore mentioned kind with a balancing section, to obtain a balanced oscillating tool.

It has been recognized as part of the invention that a really noticeable unbalance can occur, especially in the case of oscillating tools that comprise working sections projecting unilaterally to the outside from the attachment opening, which unbalance may be felt by the user as a disadvantage and may eventually impair the precision of the working process.

According to the invention, this disadvantage is avoided or reduced by providing the oscillating tool with a balancing section intended to balance the oscillating tool.

According to a first embodiment of the invention, the oscillating tool is configured to be statically balanced with respect to the pivot axis of the drive shaft.

The term “static balancing” as used in the present invention is understood to mean that mass distribution of the oscillating tool is selected so that the center of gravity coincides with the pivot axis of the drive shaft. If this is the case, no outwardly directed centrifugal force component will be encountered about the pivot axis of the oscillating drive of the oscillating tool because the different components of the oscillating tool balance each other.

According to an additional further improvement of the invention, the oscillating tool is configured to be dynamically balanced with respect to the pivot axis of the drive shaft.

If and to the extent the oscillating tool comprises sections which are located outside the plane of the attachment opening, mass eccentricities may occur in different planes perpendicular to the pivot axis, in spite of the oscillating tool being statically balanced. The axis of inertia, that extends through the centers of gravity of the different planes, will then no longer coincide with the axis of rotation. Due to that deviation of axes a pair of centrifugal forces is produced, in addition to the centrifugal force produced by the deviation of the centers of gravity that results in a couple unbalance about the pivot axis of the drive shaft during rotary movement.

That “dynamic unbalance” can likewise be balanced if the configuration of the oscillating tool is properly selected so that smoother working will be rendered possible even if the masses of the oscillating tool should be distributed very unequally.

According to a first embodiment of the invention, the balancing section of the oscillating tool is formed integrally with the oscillating tool.

In order to provide the necessary balancing mass, it is possible in this case, for example, to simply configure the balancing section as a material portion of increased length, thickness or width on the side opposite the working section of the oscillating tool, relative to the pivot axis of the drive shaft.

Where this is advantageous for reasons of geometry, the balancing section may also comprise a bent portion that may be bent over toward the working section, if desired.

This permits the balancing mass to be accommodated in a space-saving way.

According to a further embodiment of the invention, a balancing weight is attached to the balancing section.

This permits the necessary balancing mass to be accommodated in a relatively small space whereby any obstructions, that may result from the balancing section during use of the oscillating tool, can be minimized.

The balancing weight may be attached to the oscillating tool for example by welding, soldering, screwing, riveting or bonding.

In special cases, where balancing of the tool is desired only for very special applications but is not desired for other applications, the balancing weight may be detachably fastened on the oscillating tool.

The oscillating tool as such may be designed as cutting or scraping knife, as spatula or saw, for example. In addition, numerous other applications of the oscillating tool are also imaginable.

Alternatively, the object of the invention is achieved by a balancing element having an attachment opening for attachment to a drive shaft of an oscillating drive, that can be driven in oscillating fashion, which can be mounted on the drive shaft together with an unbalanced oscillating tool which latter comprises an attachment opening for attachment to the drive shaft of the oscillating drive as well as a working section, spaced from the attachment opening, for processing the work piece, the balancing element being tuned to the oscillating tool so as to allow balancing with respect to the pivot axis of the drive shaft by the balancing element in combination with the oscillating tool.

The object of the invention is perfectly achieved in this way as well. Compared with the solutions described above, an additional balancing element, which is mounted on the drive shaft together with the unbalanced oscillating tool, provides the advantage that the oscillating tool may be used either in its conventional unbalanced form or in combination with a balancing element in order to obtain a balanced assembly.

Thus, normally, the oscillating tool can be used in balanced condition while in certain cases, when the balancing section or a balancing weight would prove to be a hindrance for reasons of geometry, one can simply work with the conventional oscillating tool.

This requires of course that the balancing element be mounted by the user on the drive shaft in suitable fashion, notably opposite the projecting working section, so that balancing will be actually achieved. However, how to mount the balancing element should be clearly obvious when regarding the respective oscillating tool.

If necessary, it would also be possible to provide specifically shaped elements, fitting positively one into the other, on the oscillating tool on the one hand and the balancing element on the other hand in order to guarantee that the oscillating tool and the balancing element can be used only in a predetermined position one relative to the other.

Such a balancing element also permits static balancing or even dynamic balancing, if desired, of the assembly so formed relative to the pivot axis of the drive shaft.

The balancing element can again comprise a balancing weight that may be attached to the balancing element preferably by screwing, welding, riveting, bonding or soldering.

The balancing weight as such may consist either of the same material as the oscillating tool and/or the balancing element, or of a material of higher density so that the required balancing mass can be reached with the smallest possible outer dimensions.

It is understood that the features of the invention mentioned above and those yet to be explained below can be used not only in the respective combinations indicated, but also in other combinations or in isolation, without leaving the scope of the present invention.

### BRIEF DESCRIPTION OF THE DRAWINGS

Certain preferred embodiments of the invention will be described hereafter with reference to the drawings in which:

FIG. 1 shows a side view of an oscillating tool according to the intention, attached to an oscillating drive indicated only diagrammatically;

FIGS. 2-6 show perspective views of certain variations of an oscillating tool according to the invention; and

FIGS. 7-10 show perspective views of different configurations of a balancing element according to the invention.

### DETAILED DESCRIPTION OF THE DRAWINGS

Referring to FIG. 1, an oscillating tool according to the invention is indicated generally by reference numeral 30. The oscillating tool may, for example, be a sawing tool that carries on one of its ends a working section 32 provided with saw teeth. Arranged on the opposite end of the generally oblong oscillating tool 30 is a balancing section 34 with a balancing weight 35, the latter being indicated only diagrammatically. The oscillating tool 30 is mounted on the free end of a drive shaft 14 of an oscillating drive, shown only diagrammatically and designated by reference numeral 10, by means of a mounting opening—not shown—arranged closer to the balancing weight 35 than to the working section 32. The oscillating drive 10 is a drive of conventional design by which the drive shaft 14 can be set in oscillating motion about the pivot axis 16 of the drive shaft 14 at a high frequency of approximately 5000 to 30000 oscillations per minute and with a relatively small oscillating angle in the order of approximately 0.5 to 7 degrees. The gear mechanism required for this purpose being generally known, it is only indicated by reference numeral 12 in FIG. 1, but will not be described here in greater detail.

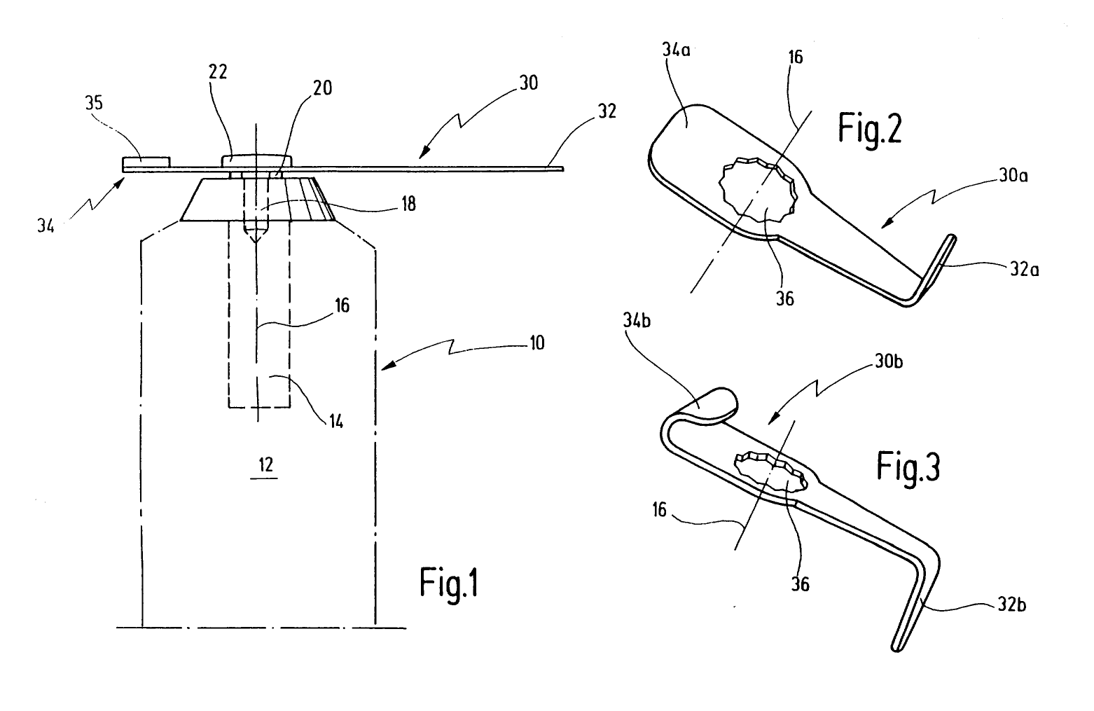

For mounting the oscillating tool 30 positively on the drive shaft 14, the latter is provided at its outer end with a mounting section in the form of a hexagon section 20 on which the oscillating tool 30 can be positively fitted with a corresponding hexagonal attachment opening or star-shaped attachment opening with 12 points (as shown, for example, in FIG. 2) using a suitable screw 22 that can be screwed into a threaded blind bore 18 in the drive shaft 14.

It is now provided according to the invention that in the case of the oscillating tool 30 the balancing weight 35 is mounted on the balancing section 34, for example by welding, on the side opposite the working section 32. The mass distribution relationships are suitably selected in this case to ensure that the oscillating tool 30 is statically balanced with respect to the pivot axis 16 of the drive shaft 14.

FIG. 2 shows a modification of an oscillating tool according to invention, generally designated by reference numeral 30a. The oscillating tool 30a, which may be a cutter with a working section 32a designed as cutting edge provided on its one end, is balanced solely by a balancing section 34a arranged opposite the working section 32a. This means that an additional balancing weight is not used in this case. Static balancing can be guaranteed by suitable selection of the shape of the balancing section and its spacing from the pivot axis 16.

However, due to the working section 32a projecting at a right angle from the plane in which the attachment opening 36 is located, the oscillating tool 30a still exhibits a certain dynamic unbalance, though this will remain practically unnoticeable due to the relatively small mass. The dynamic unbalance only results in a couple unbalance that will be hardly noticed because, usually, the outside of the oscillating drive 10 is gripped by the user's hand.

Another configuration of the oscillating tool according to the invention is shown in FIG. 3 and designated generally by reference numeral 30b.

Here again, a working section 32b in the form of a blade is provided on one end of the oscillating tool. On the opposite side of the oscillating tool 30b, there is provided a balancing section 34b, which is bent over toward the attachment opening 36 in order to permit a space-saving arrangement to be achieved.

Again, this arrangement is not balanced dynamically. For this purpose, the balancing section 34b would have to be bent over in opposite direction, i.e. to the same side on which the working section 32b extends. However, in the case illustrated in the drawing, the section was bent over to the other side in order to avoid any introduction of disturbing elements into the working area that might be felt as disturbing in operation.

Other variants of the oscillating tool according to the invention are illustrated in FIGS. 4 to 6 and are designated generally by reference numerals 30c, 30d and 30e. The oscillating tools are again mounted by means of star-shaped attachment openings 36 with 12 points, which may be punched out from the otherwise flat tool.

While a working section 32c, 32d or 32e, respectively, is provided on one free end, a balancing section 34c, 34d or 34e, respectively, is arranged on the opposite end.

In contrast to the embodiments described above with reference to FIGS. 2 and 3, balancing is achieved by the additional balancing weight 35c, 35d or 35e, respectively, attached to the balancing section.

In the case of the embodiment of the balancing element 30d shown in FIG. 5, that balancing weight 35d consists of two parts so that one half is positioned on one side of the oscillating tool 30d, while the second, identically shaped half is arranged on the opposite side.

This then generally results in a dynamically balanced oscillating tool 30d.

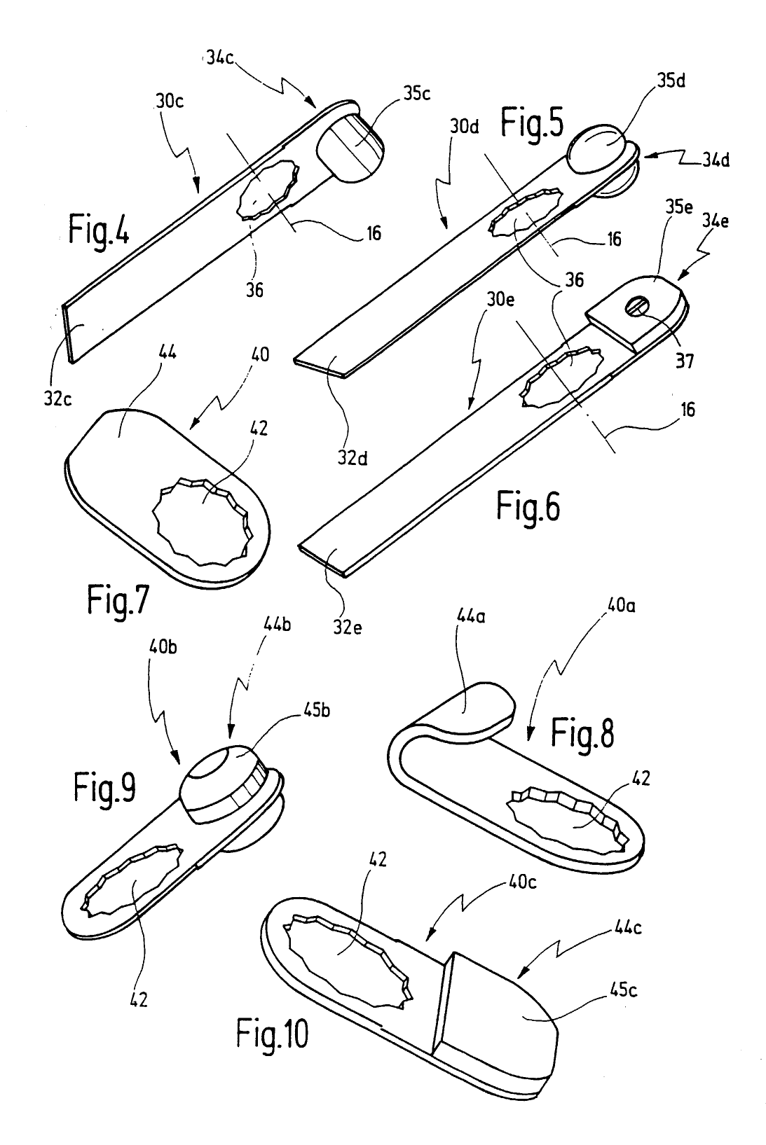

While in the embodiments shown in FIGS. 4 and 5, the shape of the balancing weight 35c or 35d, respectively, is approximately cylindrical with a rounded head (FIG. 4), or approximately that of a spherical cup (FIG. 5), the balancing weight 35e as shown in FIG. 6 exhibits a flat, plane shape adapted to the outer contour of the balancing section 34e.

The balancing weights may be connected with the remaining portion of the oscillating tool in any way, including for example by welding, soldering, screwing, riveting or bonding, or by cotter-pins. In FIG. 6 a screw 37 is shown for attaching the balancing weight to the oscillating tool.

It is of course understood that the unbalance of the oscillating tool may be reduced in advance by suitable bores, reductions in cross-section of the material, or the like, provided this does not impair the stability of the oscillating tool as such.

Another way of balancing an oscillating tool is the use of a separate balancing element, which is mounted on the drive shaft 14 together with the tool in order to achieve balancing of the assembly so formed.

Suitable balancing elements are shown in FIGS. 7 to 10 and are designated generally by reference numerals 40, 40a, 40b and 40c. The balancing elements are again provided with a correspondingly shaped attachment opening 42, which is adapted to the shape of the attachment section 20 of the drive shaft 14 so as to allow positive fitting. Each of the balancing elements 40 to 40c comprises a balancing section 44, 44a, 44b, 44c, respectively, that results in unbalance of the balancing element with respect to the pivot axis 16. In the embodiment illustrated in FIG. 7, the balancing section 44 is simply configured as a flat material section so that the general form of a flat plate is obtained.

In the embodiment illustrated in FIG. 8, the balancing section 44a is bent over toward the attachment opening 42, similar to the embodiment shown in FIG. 3.

In the embodiment illustrated in FIG. 9, two balancing weights 45b are attached to the two opposite sides of the balancing section 44b so as to provide a symmetrical arrangement.

Such a balancing element 40b may be used in combination with a flat oscillating tool in order to provide a dynamically balanced assembly.

In the case of the balancing element shown in FIG. 10, a balancing element 45c of flat shape is again mounted on the balancing section 44c similar to the arrangement described before in connection with the embodiment of the oscillating tool 30e according to FIG. 6.

1. An oscillating tool comprising:
an attachment opening for attachment to a drive shaft of an oscillating drive, that can be driven in oscillating pivot fashion about a pivot axis defined by said drive shaft;
a working section spaced from said attachment opening for processing a work piece; and
a balancing section spaced from said working section for balancing said oscillating tool.

2. The oscillating tool as defined in claim 1, wherein the oscillating tool is statically balanced with respect to the pivot axis of the drive shaft.

3. The oscillating tool as defined in claim 2, wherein the oscillating tool is dynamically balanced with respect to the pivot axis of the drive shaft.

4. The oscillating tool as defined in claim 1, wherein the balancing section, of the oscillating tool is formed integrally with the oscillating tool.

5. The oscillating tool as defined in claim 4, wherein the balancing section comprises a counter mass portion extending in a direction opposite to the working section.

6. The oscillating tool as defined in claim 4, wherein the balancing section comprises a counter mass defined by an increased thickness relative to a thickness defined by the reminder of said oscillating tool.

7. The oscillating tool as defined in claim 4, wherein the balancing section comprises a counter mass defined by an increased width relative to a width defined by the reminder of said oscillating tool.

8. The oscillating tool as defined in claim 4, wherein said balancing section comprises a bent portion.

9. The oscillating tool as defined in claim 8, wherein said balancing section comprises a portion bent toward said working section.

10. The oscillating tool as defined claim, further comprising a balancing weight is attached to said balancing section.

11. The oscillating tool as defined in claim 10, wherein said balancing weight is attached to said oscillating tool by one of the group formed by welding, soldering, screwing, riveting and bonding.

12. The oscillating tool as defined in claim 10, wherein said balancing weight is fastened detachably to said oscillating tool.

13. The oscillating tool as defined in claim 1, wherein said oscillating tool is configured as a cutting knife.

14. The oscillating tool as defined in claim 1, wherein said oscillating tool is configured as a scraping knife.

15. The oscillating tool as defined in claim 1, wherein said oscillating tool is configured as a saw.

16. A balancing weight being mated to an oscillating tool for commonly balancing said oscillating tool and said balancing weight with respect to a pivot axis about which said balancing weight and said oscillating tool can be commonly driven in an oscillating movement, wherein said oscillating tool comprises an attachment opening for attaching said drive shaft to said oscillating drive, said oscillating tool further comprising a working section spaced from said attachment opening for processing a work piece.

17. The balancing weight having an attachment opening for attaching to said oscillating tool.

18. The balancing weight as defined in claim 16, being mated to said oscillating tool so as to permit a static balancing relative to the pivot axis of the drive shaft in combination with said oscillating tool.

19. The balancing weight as defined in claim 16, being mated to said oscillating tool so as to permit a dynamic balancing relative to the pivot axis of the drive shaft in combination with said oscillating tool.

20. The balancing element as defined in claim 16, comprising an attachment means for attaching said balancing weight to said oscillating tool.

21. The balancing weight as defined in claim 16, wherein said attachment means is configured for attaching to said oscillating tool by one of screwing, welding, riveting, bonding and soldering.

22. A method of balancing an oscillating tool that is configured for being oscillatingly driven about a pivot axis by an oscillatory drive, said method comprising
providing a balancing weight;
attaching said balancing weight to said oscillating tool; and
mating said balancing weight to said oscillating tool to effect a balancing of said oscillating tool in combination with said oscillating tool relative to said pivot axis.

23. The method as defined in claim 22, wherein said step of mating comprises a static balancing of said oscillating tool in combination with said oscillating tool relative to said pivot axis.

24. The method as defined in claim 22, wherein said step of mating comprises a dynamic balancing of said oscillating tool in combination with said oscillating tool relative to said pivot axis.

25. A method of balancing an oscillating tool that is configured for being oscillatingly driven about a pivot axis by an oscillatory drive, said method comprising
providing a balancing weight;
mating said balancing weight to said oscillating tool to effect a balancing of said oscillating tool in combination with said oscillating tool relative to said pivot axis; and
attaching said balancing weight to said drive shaft.
